(19) United States
(12) Patent Application Publication
(10) Pub. No.: US 2019/0193390 A1
(43) Pub. Date: Jun. 27, 2019

(54) TABLET MARK PRINTING METHOD, TABLET MARK PRINTING DEVICE, AND TABLET

(71) Applicant: FREUND CORPORATION, Tokyo (JP)

(72) Inventors: Kiyoshi Imai, Tokyo (JP); Eiichi Hachiya, Tokyo (JP); Akira Mouri, Tokyo (JP); Mutsuhito Yoneta, Tokyo (JP)

(21) Appl. No.: 16/308,851

(22) PCT Filed: Mar. 17, 2017
(86) PCT No.: PCT/JP2017/010925

§ 371 Date: Dec. 11, 2018

(30) Foreign Application Priority Data
Jun. 25, 2016 (JP) 2016-126111

(51) Int. Cl. B41F 17/36; A61J 3/00; B41J 3/407

(52) U.S. Cl. CPC B41F 17/36; B41J 3/4073; A61J 3/007

(57) ABSTRACT

A tablet mark printing method of printing a mark at a splitting position of a tablet having a splitting line on a first surface and not having a splitting line on a second surface, the method including performing splitting line position recognition on the first surface of the tablet and printing the mark at a position corresponding to the splitting position at least on the second surface.

### TECHNICAL FIELD

The present invention relates to a tablet mark printing method, a tablet mark printing machine, and a tablet for making it easier to identify the splitting position of a tablet.

### BACKGROUND ART

A tablet may have a splitting line on one of its main surfaces along which to split the tablet in half or in quarters in accordance with the requirements in administering the medicine. Such a splitting line is provided as a groove in the form of a straight line from one end to the other end of the tablet. The splitting line makes it relatively easy to split the tablet.

However, it is difficult in some cases to identify the splitting position because the splitting line on a surface of the tablet is not different in color from the part surrounding the splitting line and because there is no splitting line on the other main surface. Splitting a tablet is expected to take place when an individual who takes the tablet splits the tablet upon instruction by a doctor and when tablets are automatically split with a multi-dose packaging device that encloses a plurality of kinds of medicines in one packet.

Patent Literature 1 describes a configuration in which the splitting line part of a tablet is marked in a different color from that of the surrounding part to make it easier to split the tablet.

### CITATION LIST

### Patent Literature

Patent Literature 1: Japanese Laid-Open Patent Application Publication No. 2015-34133.

### SUMMARY OF INVENTION

### Technical Problem

However, the technique described in Patent Literature 1 only applies marking on the tablet surface having a splitting line and is disadvantageous in that the splitting position cannot be identified when the surface without the splitting line is viewed.

An object of the present invention is to solve the above-described problem and to enable the splitting position of a tablet to be identified by visual observation or with a multi-dose packaging device even when the surface without the splitting line is viewed.

### Solution to Problem

To solve the above-described problem, the present invention provides a tablet mark printing method of printing a mark on a splitting position of a tablet having a splitting line on a first surface and not having a splitting line on a second surface, the method including: performing splitting line position recognition to recognize a position of the splitting line on the first surface of the tablet; and printing the mark at a position corresponding to the position of the splitting line at least on the second surface.

This configuration enables the splitting position of the tablet to be identified even when the surface without the splitting line is viewed by visual observation. Further, after a multi-dose packaging of tablets is carried out with a multi-dose packaging device, it is possible to inspect as to whether the tablet having the splitting line is contained in the multi-dose package by capturing an image of one surface.

The mark may be printed in a groove of the splitting line on the first surface.

This configuration enables the splitting position of the tablet to be clearly identified also on the surface with the splitting line. Further, it is possible to check the presence of a splitting line from either side of the tablet when using a multi-dose packaging device.

The mark may have a form that enables a determination as to abnormal splitting after the tablet is split.

This configuration enables a determination as to whether the tablet is split normally or abnormally after the tablet is split. Further, even when the split tablet is placed in a multi-dose package, it is possible to check whether or not the split tablet is split normally.

The mark having a form that enables a determination as to abnormal splitting after the tablet is split may include a straight line printed along a position corresponding to the splitting line in such a way as to cover both edges in a width direction of a groove of the splitting line.

According to this configuration, it is possible to determine by visual observation or with a multi-dose packaging device whether the tablet is split normally or abnormally since it is possible to determine that the tablet is split normally when the conditions that one edge in the width direction of the mark is continuous without break from one end to the other end of the tablet after the tablet is split and that the other edge in the width direction of the mark is not observed are confirmed.

Further, to solve the above-described problem, the present invention provides a tablet mark printing machine to print a mark at a splitting position of a tablet having a splitting line on a first surface and not having a splitting line on a second surface, the machine including: a recognition device to perform splitting line position recognition to recognize a position of the splitting line on the first surface of the tablet; and a second surface printing device to print the mark at a position corresponding to the position of the splitting line at least on the second surface.

This configuration enables the splitting position of the tablet to be identified even when the surface without the splitting line is viewed by visual observation. Further, after a multi-dose packaging of tablets is carried out with a multi-dose packaging device, it is possible to inspect as to whether the tablet having the splitting line is contained in the multi-dose package by capturing an image of one surface.

The tablet mark printing machine may further include a first surface printing device to print the mark in a groove of the splitting line on the first surface.

This configuration enables the splitting position of the tablet to be clearly identified also on the surface with the splitting line. Further, it is possible to check the presence of a splitting line from either side of the tablet when using a multi-dose packaging device.

The mark may have a form that enables a determination as to abnormal splitting after the tablet is split.

This configuration enables a determination as to whether the tablet is split normally or abnormally after the tablet is split. Further, even when the split tablet is placed in a multi-dose package, it is possible to check whether or not the split tablet is split normally.

The mark having a form that enables a determination as to abnormal splitting after the tablet is split may include a straight line printed along a position corresponding to the splitting line in such a way as to cover both edges in a width direction of a groove of the splitting line.

According to this configuration, it is possible to determine by visual observation or with a multi-dose packaging device whether the tablet is split normally or abnormally since it is possible to determine that the tablet is split normally when the conditions that one edge in the width direction of the mark is continuous without break from one end to the other end of the tablet after the tablet is split and that the other edge in the width direction of the mark is not observed are confirmed.

Further, to solve the above-described problem, the present invention provides a tablet having a splitting line on a first surface and not having a splitting line on a second surface, wherein a mark is printed at a position corresponding to the splitting line at least on the second surface.

This configuration enables the splitting position of the tablet to be identified even when the surface without the splitting line is viewed by visual observation. Further, after a multi-dose packaging of tablets is carried out with a multi-dose packaging device, it is possible to inspect as to whether the tablet having the splitting line is contained in the multi-dose package by capturing an image of one surface.

The mark may also be printed in a groove of the splitting line on the first surface.

This configuration enables the splitting position of the tablet to be clearly identified also on the surface with the splitting line. Further, it is possible to check the presence of a splitting line from either side of the tablet when using a multi-dose packaging device.

The mark may have a form that enables a determination as to abnormal splitting after the tablet is split.

This configuration enables a determination as to whether the tablet is split normally or abnormally after the tablet is split. Further, even when the split tablet is placed in a multi-dose package, it is possible to check whether or not the split tablet is split normally.

The mark having a form that enables a determination as to abnormal splitting after the tablet is split may include a straight line printed along a position corresponding to the splitting line in such a way as to cover both edges in a width direction of a groove of the splitting line.

According to this configuration, it is possible to determine by visual observation or with a multi-dose packaging device whether the tablet is split normally or abnormally since it is possible to determine that the tablet is split normally when the conditions that one edge in the width direction of the mark is continuous without break from one end to the other end of the tablet after the tablet is split and that the other edge in the width direction of the mark is not observed are confirmed.

### BRIEF DESCRIPTION OF DRAWINGS

FIG. 1 is a diagram for describing an example configuration of a tablet mark printing machine according to Embodiment 1 of the present invention.

FIG. 2 is a diagram for describing an example of a printing device portion of the tablet mark printing machine according to Embodiment 1 of the present invention.

FIG. 3 is a diagram for describing an example of a tablet with a mark printed thereon according to Embodiment 1 of the present invention.

FIG. 4 is a diagram for describing an example of a tablet with a mark printed thereon according to Embodiment 2 of the present invention.

FIG. 5 is a diagram for describing an example of a tablet with a mark printed thereon according to Embodiment 3 of the present invention.

FIG. 6 is a diagram for describing examples of split tablets with a mark printed thereon according to Embodiment 3 of the present invention.

FIG. 7 is a diagram for describing an example of a tablet with a mark printed thereon according to Embodiment 4 of the present invention.

### DESCRIPTION OF EMBODIMENTS

### Embodiment 1

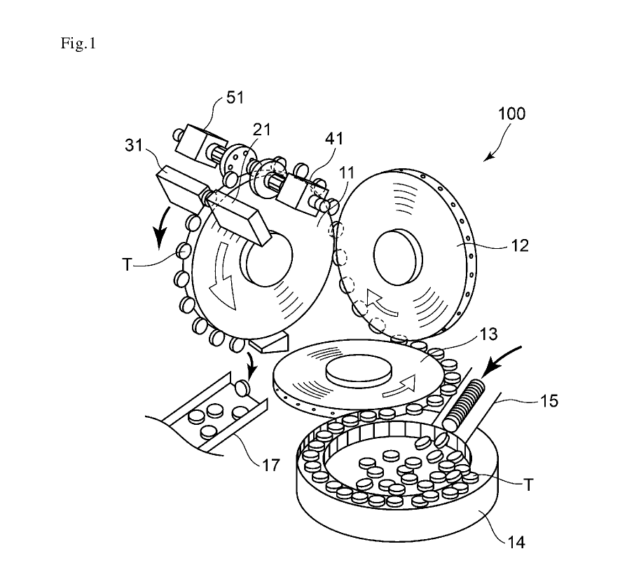

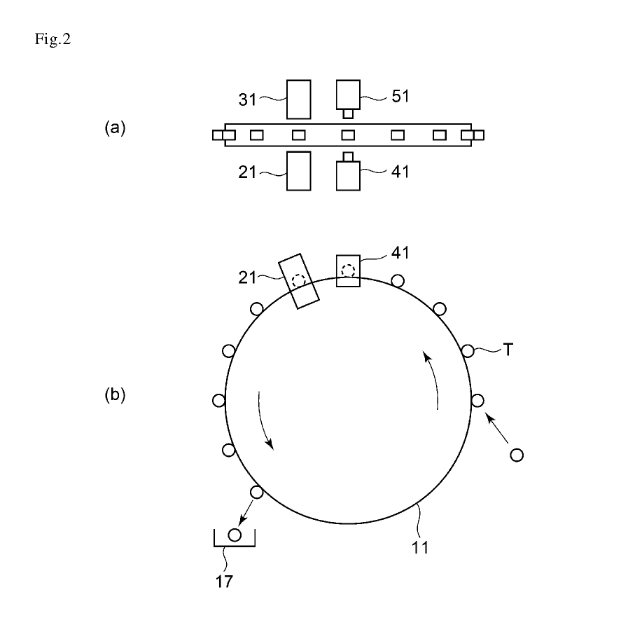

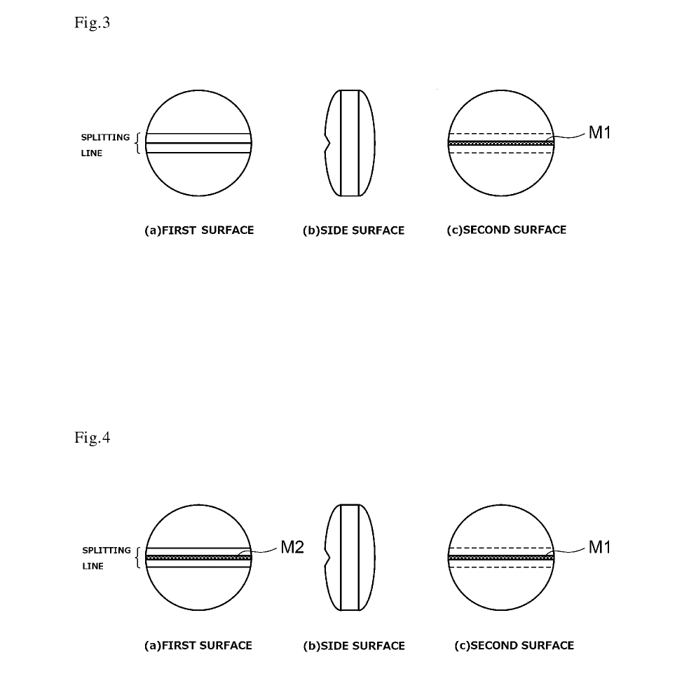

Embodiment 1 of the present invention will be described below with reference to FIGS. 1 to 3. FIG. 1 is a diagram for describing an example configuration of a tablet mark printing machine according to Embodiment 1 of the present invention. FIG. 2 is a diagram for describing an example of a printing device portion of the tablet mark printing machine according to Embodiment 1 of the present invention. FIG. 3 is a diagram for describing an example of a tablet with a mark printed thereon according to Embodiment 1 of the present invention.

As illustrated in FIG. 1, a tablet mark printing machine 100 according to Embodiment 1 of the present invention includes a disk 11, a disk 12, a disk 13, a parts feeder 14, a tablet feeding unit 15, a printing device 21, a printing device 31, an image capturing device 41, an image capturing device 51, a storage box 17, and the like. The disk 11 is arranged with the main surface thereof disposed vertically and the disk 12 is arranged vertically and perpendicularly to the disk 11 with the side surfaces of the disk 11 and the disk 12 close to each other. The disk 13 is arranged horizontally and perpendicularly to the disk 12 with the side surfaces of the disk 12 and the disk 13 close to each other. The disk 11, the disk 12, and the disk 13 have a plurality of suction holes on their circumferential side surfaces and are capable of drawing and holding tablets T by suction onto their suction holes.

It is assumed that a tablet according to the present invention has a splitting line on a first surface thereof and has no splitting line on a second surface thereof (see FIG. 3 etc.). A splitting line is a groove defined on a surface of a tablet to make the tablet easier to split when the tablet is to be split. A tablet often has one groove called a splitting line defined in the form of a straight line from one end to the other end of the tablet to enable the tablet to be split in half as illustrated in FIG. 3, but a tablet may have two grooves perpendicular to each other in the form of a cross to enable the tablet to be split in quarters. Herein the circumferential side surface between the two main surfaces, i.e., the first surface and the second surface of the tablet T will be referred to as the side surface.

Next, an operation of the tablet mark printing machine 100 will be described. First, tablets T are fed from the tablet feeding unit 15 to the parts feeder 14. The tablets T fed to the parts feeder 14 are gradually lined up in the horizontal direction by the vibration or rotation of the parts feeder 14. At a final extremity of the parts feeder 14, each of the tablets T so lined up is drawn by suction onto a nearby suction hole among the plurality of suction holes provided on the circumferential side surface of the disk 13, the side surface of the tablet T being attached onto the suction hole. As the disk 13 rotates counterclockwise, the tablet T held by suction onto the suction hole on the circumferential side surface of the disk 13 is carried in a circular horizontal movement toward the disk 12. When the tablet T comes close to the disk 12, the suction from a suction hole of the disk 12 close to the tablet T is started while the suction from the suction hole of the disk 13 is halted and one of the main surfaces of the tablet T is drawn by suction onto the suction hole of the disk 12. The disk 12 rotates clockwise to carry the tablet T held by suction thereon in a circular vertical movement toward the disk 11. When the tablet T comes close to the disk 11, the suction from a suction hole of the disk 11 close to the tablet T is started while the suction from the suction hole of the disk 12 is halted and the side surface of the tablet T is held by suction onto the suction hole of the disk 11. As the disk 11 rotates, the tablet T held by suction onto the disk 11 is carried in a counterclockwise circular vertical movement.

Next, the splitting line position recognition of a tablet T held by suction onto the disk 11 and the printing of a mark on the tablet T will be described in detail with reference to FIGS. 1 and 2. The disk 11 receives from the disk 12 a vertically positioned tablet T at the initial extremity in the direction of rotation at the side of the disk 11 by drawing by suction the side surface of the tablet T and holds the tablet T by suction in a vertical posture. As the disk 11 rotates counterclockwise, the tablets T held by suction are consecutively carried in a counterclockwise circular movement. When a tablet T is brought by the circular movement to a position at which the image capturing device 41 and the image capturing device 51 can capture images, the tablet T is detected by a sensor (not illustrated) and the image capturing device 41 captures an image of one of the main surfaces of the tablet T and the image capturing device 51 captures an image of the other of the main surfaces of the tablet T. The image capturing device 41 and the image capturing device 51 are each constituted by a CMOS sensor and capture the images of the tablet T carried in a circular movement by using an electronic shutter and strobe to obtain images without blur.

The image capturing device 41 and the image capturing device 51 are both connected to a control device (not illustrated). The control device performs image processing on the images captured by the image capturing device 41 and the image capturing device 51, determines whether a first surface with the splitting line is one of the main surfaces or the other of the main surfaces, and recognizes the position and the rotation angle of the splitting line on the first surface (to be referred to as “splitting line position recognition”). In other words, when the control device has determined that the splitting line is on one of the main surfaces, the image of which the image capturing device 41 captured, the control device determines that this one of the main surfaces is the first surface. When the control device has determined that the splitting line is on the other of the main surfaces, the image of which the image capturing device 51 captured, the control device determines that this other of the main surfaces is the first surface. The control device recognizes the position and the rotation angle of the splitting line on the surface that has been determined to be the first surface (splitting line position recognition). The position and the rotation angle of the splitting line can be recognized by image processing software. For example, a template matching technique or a boundary detection technique can be used for recognition.

Note that the position and the rotation angle of the splitting line is recognized in the splitting line position recognition in Embodiment 1 but, in a case in which the tablet T is supplied to the image capturing devices and the printing devices with the central position of the tablet T hardly out of alignment, the rotation angle may be recognized alone, the position of the splitting line not being recognized.

The tablet T for which the splitting line position recognition has been completed is conveyed in a circular movement to the position at which the printing device 21 and the printing device 31 can print a mark on the tablet T. The printing device 21 and the printing device 31 are each constituted by an inkjet printer and print a mark in a freely selected form by discharging ink from nozzles. In Embodiment 1, a mark M1 is printed by a second surface printing device that faces the second surface, which has been determined to be without the splitting line.

Herein the second surface printing device means the printing device 21 or the printing device 31 that applies printing on the second surface of the tablet T, i.e., the surface without the splitting line. For example, in FIG. 1 or FIG. 2, when the splitting line is on the surface facing the viewer, i.e., one of the main surfaces, the printing device 21 is the second surface printing device and when the splitting line is on the surface facing away from the viewer, i.e., the other of the main surfaces, the printing device 31 is the second surface printing device.

The printing device 21 and the printing device 31 are both connected to a control device (not illustrated). The control device performs control to execute printing by giving the print data that defines the form of the mark to the printing device that executes printing, i.e., the printing device 21 or the printing device 31.

Thus, in Embodiment 1, at least a mark is printed at the position and the rotation angle corresponding to the position of the splitting line on the second surface. In other words, the position and the rotation angle on the second surface (i.e., the position corresponding to the position of the splitting line on the second surface) are calculated by reversing the position and the rotation angle of the splitting line on the first surface obtained by splitting line position recognition, and a solid straight line is printed as a mark at the position and the rotation angle from one end to the other end of the tablet. The mark may be printed in any color but a mark is easier to recognize when printed in a different color from that of the tablet surface. FIG. 3 illustrates an example in which a solid straight line is printed on the second surface as a mark M1.

Note that, although a solid straight line is printed as mark M1 in Embodiment 1, the form of the mark is not necessarily limited thereto and may be selected as appropriate in accordance with the requirements of the tablet. For example, a dashed or dotted straight line may be printed or a long dashed short dashed line may be printed. Further, characters such as the name of the medicine and the name of the company may be printed in addition to the mark M1. Further, the width of the mark M1 may be freely selected and a mark width that makes the mark recognizable may be selected in accordance with the requirements of the tablet. The length of the mark M1 may also be freely selected and the mark M1 need not extend from one end to the other end of the tablet.

As the disk 11 rotates counterclockwise, the tablet T with the mark M1 printed thereon is stored in the storage box 17 near the extremity in the direction of rotation of the disk 11.

Note that, although no appearance inspection nor print inspection is performed on the tablet T in Embodiment 1, an appearance inspection may be performed to detect brakeage or chipping depending on the requirements of the tablet T, together with the splitting line position recognition. Further, a print inspection may be performed after the mark M1 is printed. Further, a side surface appearance inspection may be performed by capturing an image of the side surface of the tablet T with an image capturing device while one of the main surfaces of the tablet T is held by suction onto the disk 12.

As described above, in Embodiment 1, the splitting position of a tablet can be identified by visual observation or with a multi-dose packaging device even when the surface without the splitting line is viewed, owing to a tablet mark printing method of printing a mark on a splitting position of a tablet having a splitting line on a first surface and not having a splitting line on a second surface, the method including: performing splitting line position recognition to recognize a position of the splitting line on the first surface of the tablet; and printing the mark at a position corresponding to the position of the splitting line at least on the second surface.

Further, the splitting position of a tablet can be identified by visual observation or with a multi-dose packaging device even when the surface without the splitting line is viewed, owing to a tablet mark printing machine to print a mark at a splitting position of a tablet having a splitting line on a first surface and not having a splitting line on a second surface, the machine including: a recognition device to perform splitting line position recognition to recognize a position of the splitting line on the first surface of the tablet; and a second surface printing device to print the mark at a position corresponding to the position of the splitting line at least on the second surface.

Further, the splitting position of a tablet can be identified by visual observation or with a multi-dose packaging device even when the surface without the splitting line is viewed, owing to a tablet having a splitting line on a first surface and not having a splitting line on a second surface, wherein a mark is printed at a position corresponding to the splitting line at least on the second surface.

### Embodiment 2

Embodiment 2 of the present invention differs from Embodiment 1 in that a mark is also printed in the groove of the splitting line on the first surface in addition to the second surface of the tablet. Embodiment 2 will be described below with reference to FIG. 4. FIG. 4 is a diagram for describing an example of a tablet with a mark printed thereon according to Embodiment 2 of the present invention.

As in Embodiment 1, when a tablet T is brought by the disk 11 in a circular movement to a position at which the image capturing device 41 and the image capturing device 51 can capture images, the tablet T is detected by a sensor (not illustrated) and the image capturing device 41 captures an image of one of the main surfaces of the tablet T and the image capturing device 51 captures an image of the other of the main surfaces of the tablet T. A control device (not illustrated) performs image processing on the images captured by the image capturing device 41 and the image capturing device 51, determines whether a first surface with the splitting line is one of the main surfaces or the other of the main surfaces, and recognizes the position and the rotation angle of the splitting line on the first surface (to be referred to as “splitting line position recognition”). In other words, when the control device has determined that the splitting line is on one of the main surfaces, the image of which the image capturing device 41 captured, the control device determines that this one of the main surfaces is the first surface. When the control device has determined that the splitting line is on the other of the main surfaces, the image of which the image capturing device 51 captured, the control device determines that this other of the main surfaces is the first surface. The control device recognizes the position and the rotation angle of the splitting line on the surface that has been determined to be the first surface (splitting line position recognition).

The tablet T for which the splitting line position recognition has been completed is conveyed in a circular movement to the position at which the printing device 21 and the printing device 31 can print a mark on the tablet T. The printing device 21 and the printing device 31 are each constituted by an inkjet printer and print a mark in a freely selected form by discharging ink from nozzles. In Embodiment 2, a mark M2, which is a solid straight line, is printed in the groove of the splitting line from one end to the other end of the tablet by a first surface printing device facing the first surface with the splitting line, in addition to the mark M1 printed by the second surface printing device facing the second surface (see FIG. 4).

Note that, although a solid straight line is printed as mark M2 in Embodiment 2, the form of the mark is not necessarily limited thereto and may be selected as appropriate in accordance with the requirements of the tablet. For example, a dashed or dotted straight line may be printed or a long dashed short dashed line may be printed. Further, characters such as the name of the medicine and the name of the company may be printed in addition to the mark M2. Further, the width of the mark M1 may be freely selected and a mark width that makes the mark recognizable may be selected in accordance with the requirements of the tablet. The length of the mark M1 may also be freely selected and the mark M1 need not extend from one end to the other end of the tablet. Further, the mark M1 on the second surface and the mark M2 on the first surface may be marks in different forms.

Thus, in Embodiment 2, since a mark is also printed in the groove of the splitting line on the first surface as well as on the second surface of the tablet, the splitting position of the tablet can be clearly identified by visual observation or with a multi-dose packaging device also on the surface with the splitting line.

### Embodiment 3

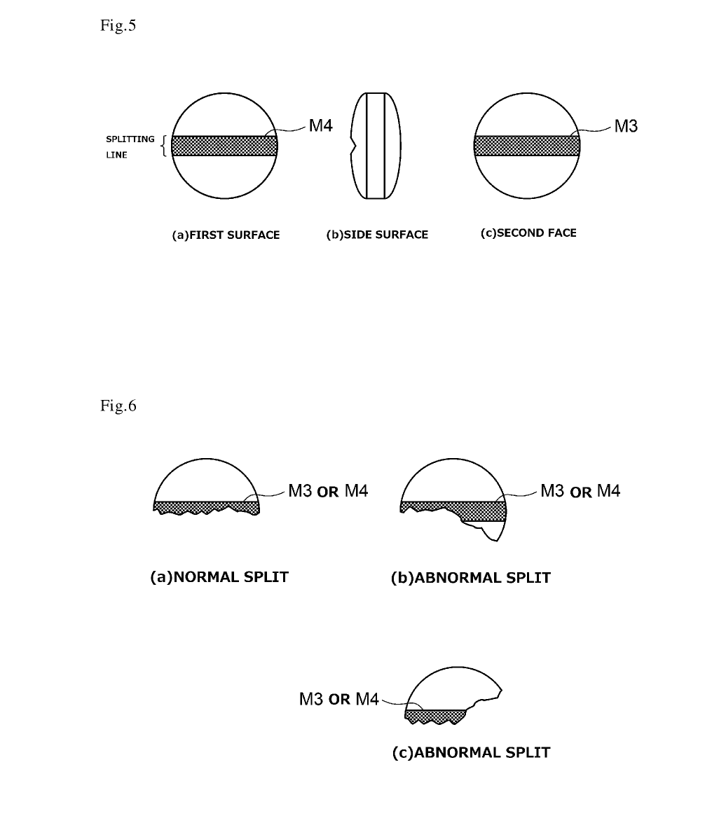

Embodiment 3 of the present invention differs from Embodiment 1 or Embodiment 2 in that the mark printed on a tablet has a form that enables a determination as to abnormal splitting after the tablet is split. Embodiment 3 will be described below with reference to FIGS. 5 and 6. FIG. 5 is a diagram for describing an example of a tablet with a mark printed thereon according to Embodiment 3 of the present invention. FIG. 6 (a) is a diagram for describing an example of a normal splitting of a tablet with a mark printed thereon according to Embodiment 3 of the present invention. FIG. 6 (b) is a diagram for describing an example of an abnormal splitting of a tablet with a mark printed thereon according to Embodiment 3 of the present invention. FIG. 6 (c) is a diagram for describing another example of an abnormal splitting of a tablet with a mark printed thereon according to Embodiment 3 of the present invention.

That the mark printed on a tablet has a form that enables a determination as to abnormal splitting after the tablet is split means that it is possible to determine whether the tablet is split normally or abnormally by looking at the mark after the tablet is split. FIG. 5 illustrates an example of a mark having a form that enables a determination as to abnormal splitting after the tablet is split. The mark M3 illustrated in FIG. 5 is an example of printing a straight line along the position corresponding to the splitting line on the second surface in such a way as to cover both edges in the width direction of the groove of the splitting line and the mark M4 is an example of printing a straight line along the position corresponding to the splitting line on the first surface in such a way as to cover both edges in the width direction of the groove of the splitting line. The mark M3 and the mark M4 are straight lines printed along the positions corresponding to the splitting line in such a way as to at least cover both edges in the width direction of the groove of the splitting line.

Herein, on the first surface, a straight line printed along the splitting line in such a way as to cover the positions corresponding to both edges in the width direction of the groove of the splitting line may be a straight line printed along the splitting line and covering both edges in the width direction defining the groove of the splitting line and may be a straight line that includes some positions out of the groove. Further, on the second surface, the line may be a straight line printed at the position and the rotation angle corresponding to the splitting line and having a width covering both edges in the width direction defining the groove of the splitting line on the first surface and may be somewhat wider. Further, the straight lines of the mark M3 and the mark M4 in Embodiment 3 are solid lines but the lines are not necessarily limited thereto and may be broken lines, dotted lines, or long dashed short dashed lines. Further, the mark M3 and the mark M4 may be marks in different forms from each other.

FIG. 6 illustrates examples of a split tablet T with the mark M3 and the mark M4 illustrated in FIG. 5 printed thereon. FIG. 6 (a) illustrates an example of a normal splitting. In other words, in a normal splitting, it is observed that one edge in the width direction of the mark M3 or the mark M4 is continuous without break from one end to the other end of the tablet T and the other edge in the width direction of the mark M3 or the mark M4 is not observed. In contrast, in an abnormal splitting, it is observed that one edge in the width direction of the mark M3 or the mark M4 is continuous without break from one end to the other end of the tablet T and at least part of the other edge in the width direction of the mark M3 or the mark M4 is observed (FIG. 6 (b)). In another example, it is not observed that one edge in the width direction of the mark M3 or the mark M4 is continuous without break from one end to the other end of the tablet T (part of the edge is missing) (FIG. 6 (c)).

In other words, it is possible to determine that the tablet is split normally when the conditions that one edge in the width direction of the mark M3 or the mark M4 is continuous without break from one end to the other end of the tablet T and that the other edge in the width direction of the mark M3 or the mark M4 is not observed are confirmed. It is possible to determine that the tablet is split abnormally when not all the conditions are confirmed.

Note that, although the first surface has a mark M4 printed thereon and the second surface has a mark M3 printed thereon in Embodiment 3, the configuration is not necessarily limited thereto and the first surface may have no mark, with only the second surface having a mark M3 printed thereon.

Thus, in Embodiment 3, it is possible to determine by visual observation or with a multi-dose packaging device whether the tablet is split normally or abnormally after the tablet is split.

### Embodiment 4

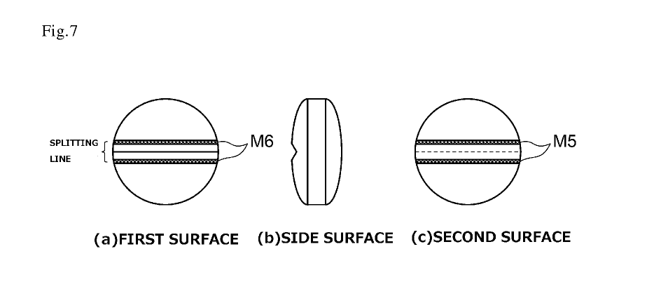

Embodiment 4 of the present invention differs from Embodiment 3 in that the mark includes two straight lines printed along the splitting line in such a way as to cover the positions corresponding to both edges in the width direction of the groove of the splitting line. Embodiment 4 will be described below with reference to FIG. 7. FIG. 7 is a diagram for describing an example of a tablet with a mark printed thereon according to Embodiment 4 of the present invention.

In Embodiment 4, as illustrated in FIG. 7, the mark M5 on the second surface of the tablet T includes two straight lines printed from one end to the other end of the tablet T at the position and the rotation angle corresponding to the splitting line in such a way as to cover both edges in the width direction defining the groove of the splitting line on the first surface, the straight lines consisting of one straight line at a position corresponding to one edge in the width direction of the groove and the other straight line at a position corresponding to the other edge. Further, the mark M6 includes two straight lines printed along the splitting line in such a way as to cover the edges in the width direction defining the groove of the splitting line, the straight lines consisting of one straight line at a position corresponding to one edge in the width direction of the groove and the other straight line at a position corresponding to the other edge. In other words, no mark is printed at a position corresponding to the central portion in the width direction of the groove.

Herein, the mark M5 or the mark M6 may be a straight line and may be a dashed line, a dotted straight line, or a long dashed short dashed line. Further, although the first surface has a mark M6 printed thereon and the second surface has a mark M5 printed thereon in Embodiment 4, the configuration is not necessarily limited thereto and the first surface may have no mark, with only the second surface having a mark M5 printed thereon. Further, the mark M6 and the mark M5 may be marks in different forms from each other.

The M5 or the M6 in Embodiment 4 also has a form that enables a determination as to abnormal splitting after the tablet is split. In other words, in a normal splitting, it is observed that one edge in the width direction of the mark M5 or the mark M6 is continuous without break from one end to the other end of the tablet T and the other edge in the width direction of the mark M5 or the mark M6 is not observed. Further, in an abnormal splitting, it is observed that one edge in the width direction of the mark M5 or the mark M6 is continuous without break from one end to the other end of the tablet T and at least part of the other edge in the width direction of the mark M5 or the mark M6 is observed. In another example, it is not observed that one edge in the width direction of the mark M5 or the mark M6 is continuous without break from one end to the other end of the tablet T (part of the edge is missing).

In other words, it is possible to determine that the tablet is split normally when the conditions that one edge in the width direction of the mark M5 or the mark M6 is continuous without break from one end to the other end of the tablet T and that the other edge in the width direction of the mark M5 or the mark M6 is not observed are confirmed. It is possible to determine that the tablet is split abnormally when not all the conditions are confirmed.

Thus, in Embodiment 4, it is possible to save the ink as no mark is printed on the middle portion in the direction of the groove since the mark includes two straight lines printed along the splitting line in such a way as to cover the positions corresponding to both edges in the width direction of the groove of the splitting line, the straight lines consisting of one straight line at a position corresponding to one edge in the width direction of the groove and the other straight line at a position corresponding to the other edge, and further, it is possible to determine by visual observation or with a multi-dose packaging device whether the tablet is split normally or abnormally after the tablet is split since the mark has a form that enables a determination as to abnormal splitting after the tablet is split.

### INDUSTRIAL APPLICABILITY

A tablet mark printing method, a tablet mark printing machine, and a tablet according to the present invention can be applied widely in areas in which it is necessary to split a tablet.

### REFERENCE SIGNS LIST

11 disk
12 disk
13 disk
14 parts feeder
15 tablet feeding unit
17 storage box
21 printing device
31 printing device
41 image capturing device
51 image capturing device
M1 to M6 mark
T tablet

1. A tablet mark printing method of printing a mark on a splitting position of a tablet having a splitting line on a first surface and not having a splitting line on a second surface, the method comprising:
performing splitting line position recognition to recognize a position of the splitting line on the first surface of the tablet; and
printing the mark at a position corresponding to the position of the splitting line at least on the second surface.

2. The tablet mark printing method according to claim 1, further comprising printing the mark in a groove of the splitting line on the first surface.

3. The tablet mark printing method according to claim 1, wherein the mark has a form that enables a determination as to abnormal splitting after the tablet is split.

4. The tablet mark printing method according to claim 3, wherein the mark having a form that enables a determination as to abnormal splitting after the tablet is split comprises a straight line printed along a position corresponding to the splitting line in such a way as to cover both edges in a width direction of a groove of the splitting line.

5. A tablet mark printing machine to print a mark at a splitting position of a tablet having a splitting line on a first surface and not having a splitting line on a second surface, the machine comprising:
a recognition device to perform splitting line position recognition to recognize a position of the splitting line on the first surface of the tablet; and
a second surface printing device to print the mark at a position corresponding to the position of the splitting line at least on the second surface.

6. The tablet mark printing machine according to claim 5, further comprising a first surface printing device to print the mark in a groove of the splitting line on the first surface.

7. The tablet mark printing machine according to claim 5, wherein the mark has a form that enables a determination as to abnormal splitting after the tablet is split.

8. The tablet mark printing machine according to claim 7, wherein the mark having a form that enables a determination as to abnormal splitting after the tablet is split comprises a straight line printed along a position corresponding to the splitting line in such a way as to cover both edges in a width direction of a groove of the splitting line.

9. A tablet having a splitting line on a first surface and not having a splitting line on a second surface, wherein a mark is printed at a position corresponding to the splitting line at least on the second surface.

10. The tablet according to claim 9 wherein the mark is also printed in a groove of the splitting line on the first surface.

11. The tablet according to claim 9 wherein the mark has a form that enables a determination as to abnormal splitting after the tablet is split.

12. The tablet according to claim 11, wherein the mark having a form that enables a determination as to abnormal splitting after the tablet is split comprises a straight line printed along a position corresponding to the splitting line in such a way as to cover both edges in a width direction of a groove of the splitting line.

13. The tablet mark printing method according to claim 2, wherein the mark has a form that enables a determination as to abnormal splitting after the tablet is split.

14. The tablet mark printing method according to claim 13, wherein the mark having a form that enables a determination as to abnormal splitting after the tablet is split comprises a straight line printed along a position corresponding to the splitting line in such a way as to cover both edges in a width direction of a groove of the splitting line.

15. The tablet mark printing machine according to claim 6, wherein the mark has a form that enables a determination as to abnormal splitting after the tablet is split.

16. The tablet mark printing machine according to claim 15, wherein the mark having a form that enables a determination as to abnormal splitting after the tablet is split comprises a straight line printed along a position corresponding to the splitting line in such a way as to cover both edges in a width direction of a groove of the splitting line.

17. The tablet according to claim 10 wherein the mark has a form that enables a determination as to abnormal splitting after the tablet is split.

18. The tablet according to claim 17, wherein the mark having a form that enables a determination as to abnormal splitting after the tablet is split comprises a straight line printed along a position corresponding to the splitting line in such a way as to cover both edges in a width direction of a groove of the splitting line.
